(19) United States
(12) Patent Application Publication
(10) Pub. No.: US 2021/0361126 A1
(43) Pub. Date: Nov. 25, 2021

(54) TOUCHLESS DISPENSER

(71) Applicant: Adams Rite Aerospace, Inc., Fullerton, CA (US)

(72) Inventors: Thanh Tran, Anaheim, CA (US); Brian Lieu, Chino Hills, CA (US); Leo Borado, Anaheim, CA (US); Dan Lau, Torrance, CA (US); Enoch Hwang, La Habra, CA (US); Juan Pena, Ontario, CA (US); Chris Selstad, Yorba Linda, CA (US)

(21) Appl. No.: 17/324,772

(22) Filed: May 19, 2021

Related U.S. Application Data
(60) Provisional application No. 63/026,995, filed on May 19, 2020.

(51) Int. Cl. A47K 5/12

(52) U.S. Cl. CPC A47K 5/1217; A47K 5/1202

(57) ABSTRACT

Provided is a touchless dispenser including a body, a motor housing coupled to the body, a control assembly including a control board, a motor communicatively coupled to the control board, a cam coupled to the motor, an actuator driven between first and second positions by movement of the cam, and a sensor communicatively coupled to the control board, a reservoir coupled to the body for holding fluid, and a tube assembly having an inlet coupled to the reservoir to receive fluid from the reservoir and an outlet positioned forward of the sensor. The sensor can sense a presence of a user, which is communicated to the control board to cause the actuator to be driven from the first position to the second position to contact the tube assembly to dispense fluid in the tube assembly to the user.

### RELATED APPLICATIONS

This application claims the benefit of U.S. Provisional Application No. 63/026,995 filed May 19, 2020, which is hereby incorporated herein by reference.

### FIELD OF INVENTION

The present invention relates generally to a touchless dispenser, and more particularly to a touchless dispenser for a lavatory.

### BACKGROUND

Dispensers may be provided for dispensing a liquid, such as a liquid soap or hand sanitizer. The dispensers may sit on a counter or attach to a wall for example.

### SUMMARY OF INVENTION

The present application provides a touchless dispenser for sensing a presence of a user's hands and dispensing a fluid to the user once the user's hands are positioned below an outlet.

According to an aspect, a touchless dispenser is provided including a body, a motor housing coupled to the body and defining a chamber, a control assembly at least partially disposed in the chamber, the control assembly including a control board, a motor communicatively coupled to the control board, a cam coupled to the motor, an actuator configured to be driven between first and second positions by movement of the cam, and a sensor communicatively coupled to the control board, a reservoir coupled to the body for holding fluid, and a tube assembly having an inlet coupled to the reservoir to receive fluid from the reservoir and an outlet positioned forward of the sensor through which the fluid is dispensed, wherein the sensor is configured to sense a presence of a user, which is communicated to the control board to cause the actuator to be driven from the first position to the second position to contact the tube assembly to dispense the fluid in the tube assembly to the user.

According to another aspect, a touchless dispenser is provided including a body, a vertical mounting plate coupled to a rear of the body and including a plurality of openings for receiving respective lock pins of a mounting bracket for mounting the dispenser to a vertical surface, a horizontal mounting plate coupled to a bottom of the body and including a plurality of openings for receiving the respective lock pins of the mounting bracket for mounting the dispenser to a horizontal surface, a motor housing coupled to the body, a control assembly at least partially disposed in motor housing, a reservoir coupled to the body for holding fluid, and a tube assembly having an inlet coupled to the reservoir to receive fluid from the reservoir and an outlet through which the fluid is dispensed.

According to still another aspect, a method of operating a dispenser having a body, a motor housing coupled to the body, a reservoir coupled to the body for holding a fluid, and a tube assembly having an inlet and outlet is provided. The method includes sensing a presence of a user via an IR sensor positioned rearward of the outlet of the tube assembly, communicating the presence of the user to a control board disposed in the motor housing, driving a cam to rotate to drive an actuator from a first position to a second position contacting the tube assembly via a command from the control board, and delivering fluid from the outlet of the tube assembly to the user, wherein the cam contacts a cam switch after being driven to communicate to the control board to turn off a motor to prevent dispensing until another presence is detected.

The foregoing and other features of the application are described below with reference to the drawings.

### BRIEF DESCRIPTION OF THE DRAWINGS

FIG. 1 is a perspective view of an exemplary touchless dispenser.

FIG. 2 is a front view of the touchless dispenser.

FIG. 3 is a side view of the touchless dispenser

FIG. 4 is a rear view of the touchless dispenser.

FIG. 5 is a bottom view of the touchless dispenser.

FIG. 6 is an exploded view of the touchless dispenser.

FIG. 7 is a cross-sectional view taken about line 7-7 in FIG. 5.

FIG. 8 is a side view of a motor housing.

FIG. 9 is a rear view of the motor housing and a control assembly.

FIG. 10 is an exploded view of the motor housing and control assembly.

FIG. 11 is a cross-sectional view taken about line 11-11 in FIG. 3.

FIG. 12 is a perspective view of a motor assembly.

FIG. 13 is an exploded view of the motor assembly.

### DETAILED DESCRIPTION

The principles of the present application relate to a touchless dispenser for dispensing liquid soap, hand sanitizer, etc. in an aircraft lavatory, and thus will be described below in this context. It will be appreciated that the principles of the application may be applicable to dispensers for other applications, for example dispenser of other liquids located in any suitable environment.

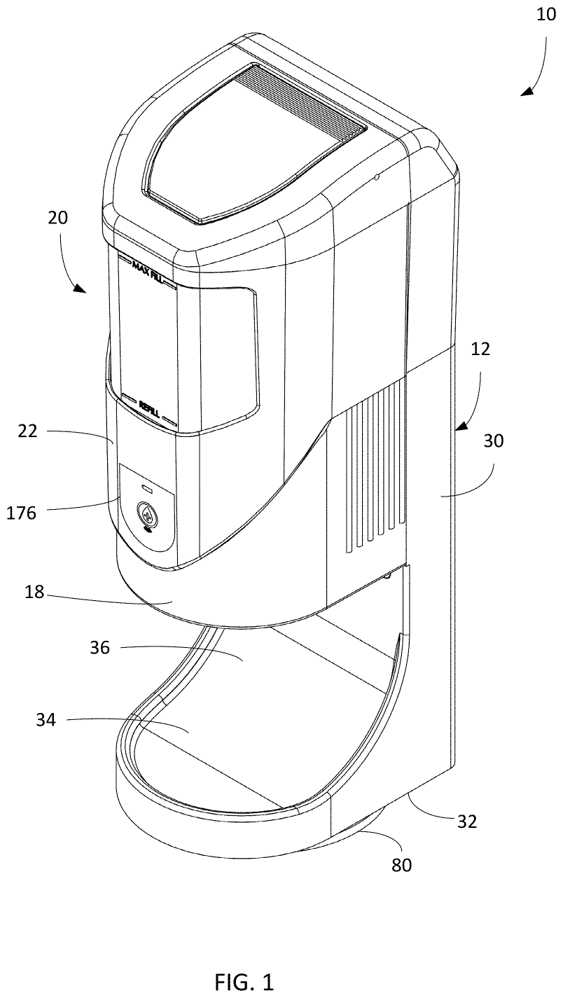

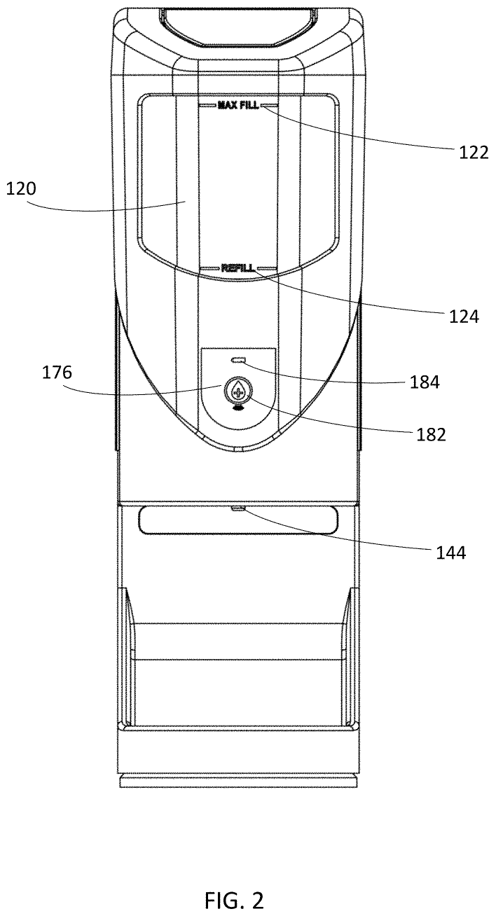

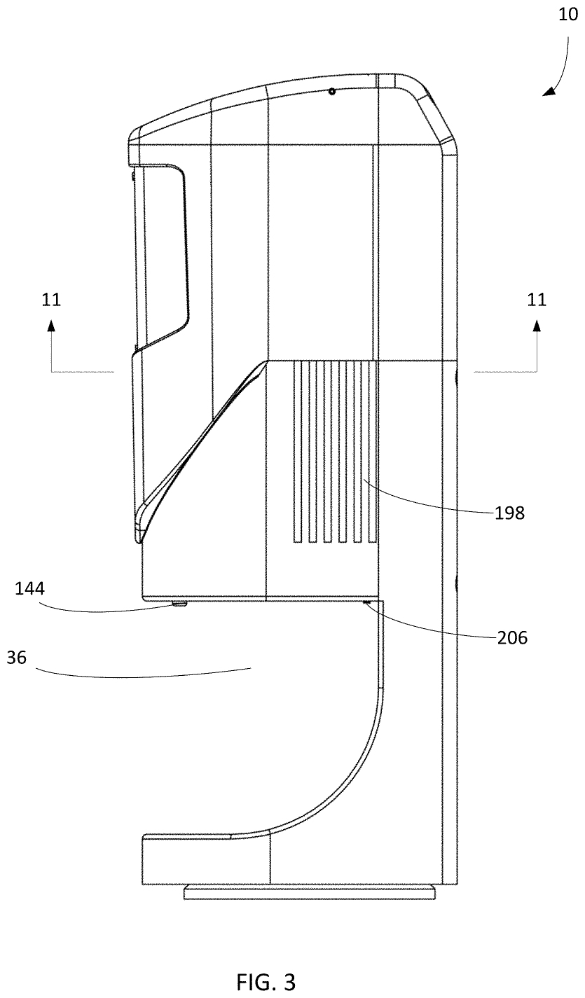

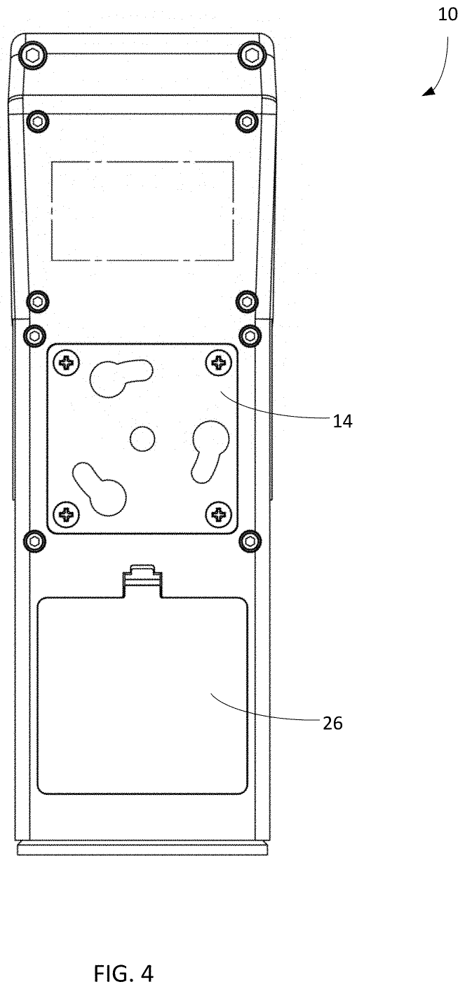

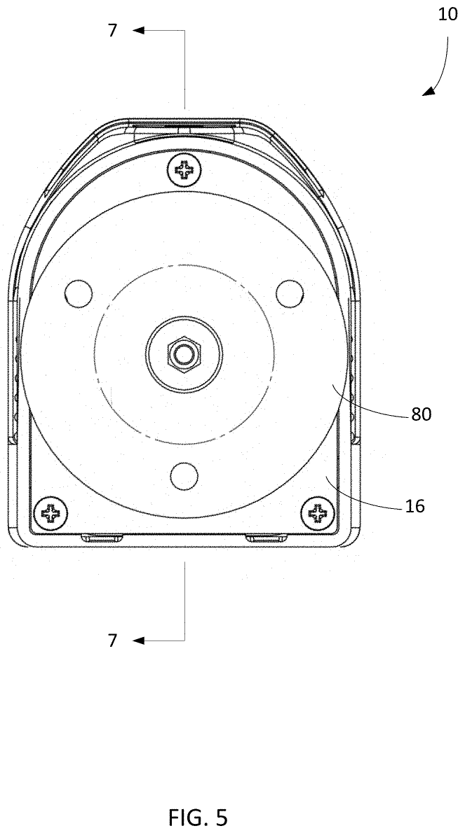

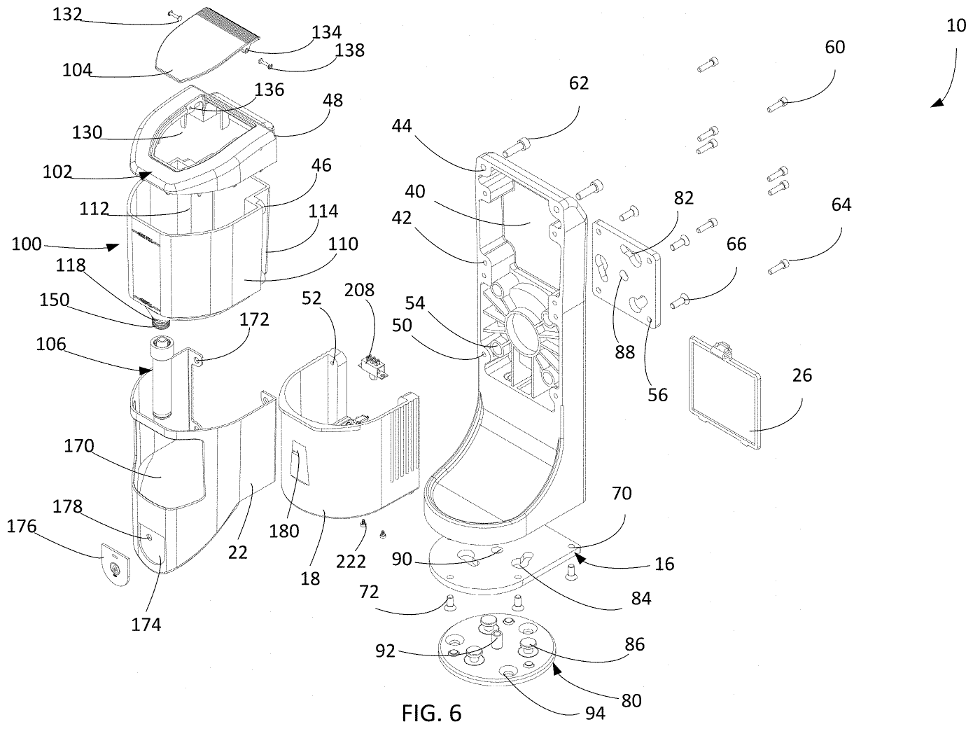

Turning initially to FIGS. 1-6, an exemplary touchless dispenser is illustrated at reference numeral 10. The dispenser 10 includes a body 12, a vertical mounting plate 14 attached to a rear of the body 12, a horizontal mounting plate 16 attached to a bottom of the body 12, a motor housing 18 attached to a front of the body 12, a reservoir assembly 20 attached to the front of the body 12 above the motor housing 18, and a cover 22 attached to the front of the body 12 to cover at least a portion of the reservoir assembly 20 and the motor housing 18. The body, plates, housing, reservoir assembly, and cover may be made of a suitable material, such as plastic to provide for corrosion resistance and weight savings, such as a polyetherimide resin suitable for use with potable water, and the components may be made in a suitable manner, such as by injection molding, machining, etc.

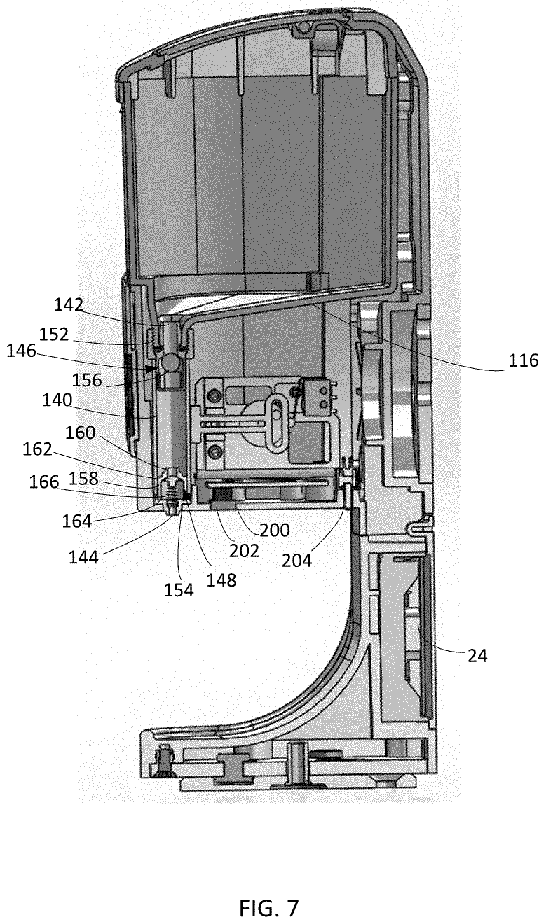

The body 12 may include a recessed area 24 (FIG. 7) at the rear of the body 12 for receiving a power source, such as a plurality of batteries, to provide power to the dispenser 10. The recessed area 24 may be closed by a suitable cover 26 that is removably connected to the body 12 in any suitable manner, such as by a tab, fasteners, etc. It will also be appreciated that a power cable may be provided for connecting the dispenser 10 to a source of electricity either in addition to or as an alternative to the batteries.

The body 12 also includes a vertical portion 30 configured to abut or be in close proximity to a wall or other vertical surface when mounted via the vertical mounting plate 14, and a horizontal portion 32 configured to abut or be in close proximity to a counter or other horizontal surface when mounted via the horizontal mounting plate 16. The horizontal portion 32 may have a curved upper surface 34 that defines with a bottom of the motor housing 18 an area 36 for receiving a user's hands. The curved upper surface 34 may also serves as a drip tray for fluid. The vertical portion 30 and horizontal portion 32 may be formed as one piece, or as several pieces coupled together in any suitable manner.

The vertical mounting plate 14, the motor housing 18, the reservoir assembly 20, and the cover 22 may all attach to the vertical portion 30 in a suitable manner. For example, the vertical portion 30 includes an opening 40 through which a portion of the reservoir assembly 20 extends, a plurality of openings 42 and 44 for aligning with corresponding openings 46 and 48 in the reservoir assembly 20, a plurality of openings 50 for aligning with corresponding openings 52 in the motor housing 18, and a plurality of openings 54 for aligning with corresponding openings 56 in the vertical mounting plate 14. The openings are configured to receive suitable fasteners to couple the components together. For example, the openings 42 and 46 may receive fasteners 60, the openings 44 and 48 may receive fasteners 62, the openings 50 and 52 may receive fasteners 64, and the openings 54 and 56 may receive fasteners 66.

Similarly, the horizontal mounting plate 16 may attach to the horizontal portion 32 in a suitable manner. For example, the horizontal portion 32 includes a plurality of openings (not shown) that align with corresponding openings 70 in the horizontal mounting plate 16. The openings in the horizontal portion 32 and the openings 70 receive suitable fasteners to couple the components together, such as fasteners 72.

The vertical mounting plate 14 and the horizontal mounting plate 16 each include additional openings for coupling to a mounting bracket 80 or the like, which allows for attachment to or removal from a vertical surface or a horizontal surface, for example to allow a member of a flight crew to transport the dispenser 10 to/from other parts of the aircraft. For example, the vertical mounting plate 14 and the horizontal mounting plate 16 include a plurality of respective openings 82 and 84 each having a first portion that receives a respective lock pin 86 of the mounting bracket 80 and a second portion smaller than the first portion that secures to the respective lock pin 86 upon rotation of mounting bracket relative to the plate 14 or 16. The vertical mounting plate 14 and the horizontal mounting plate 16 also include respective openings 88 and 90 that receive an alignment pin 92 of the mounting bracket 80 that assists with alignment of the dispenser 10 relative to the vertical mounting plate 14 or the horizontal mounting plate 16. The mounting bracket 80 can also include a plurality of openings 94 that receive suitable fasteners to secure the mounting bracket 80 to the wall or surface.

Turning now to the reservoir assembly 20 in detail, the reservoir assembly includes a reservoir 100, a cover 102 at a top of the reservoir 100, a flap 104 pivotally coupled to the cover 102, and a tube assembly 106 coupled to a bottom of the reservoir 100.

The reservoir 100 includes a main body 110 defining a chamber 112 for receiving a fluid, such as soap or sanitizer, a stepped portion 114 at a rear of the main body 110, a bottom portion 116 (FIG. 7) sloping toward a front of the main body 110, and an outlet port 118 at a front of the bottom portion 116. The stepped portion 114 includes a portion that abuts the vertical portion 30 and includes the plurality of openings 46 that align with the openings 42 in the vertical portion 30 to receive the fasteners 60, and a portion that is received in the opening 40 in the vertical portion 30. The main body 110 may include at least a portion 120 at the front of the main body 110 that is transparent or is otherwise attached to a transparent portion to allow for the level of fluid to be visually determined. The main body 110 may also include indicia on the transparent portion 120, such as indicia 122 indicating a maximum fill line and indicia 124 indicating that the fluid level should be refilled. The indicia 122 and 124 may be molded onto the portion 120 or incorporated in other suitable manner.

The cover 102 abuts the top of the reservoir 100 and includes an opening 130 for receiving the flap 104 and the plurality of openings 48 that align with the openings 44 in the vertical portion 30 to receive the fasteners 62. The flap 104 may be pivotally coupled to the cover 102 at the opening 130 in any suitable manner, such as by pins 132 received in openings 134 at opposite sides of the flap 104 that are also received in corresponding openings 136 in the cover 102 and held by suitable retainers 138. The flap 104 is pivotable relative to the cover 102 to enable refilling of the reservoir 100 without removal of the dispenser 10 from the mounting bracket 80.

Referring additionally to FIG. 7, the tube assembly 106 includes a tube 140 having an inlet 142 and outlet 144, a first valve 146 at the inlet 142 of the tube 140, and a second valve 148 at the outlet 144 of the tube 140. The tube assembly 106 may be coupled to the outlet port 118 of the reservoir 100 in any suitable manner, for example by threads 150 on an outer surface of the outlet port 118 that mate with threads 152 on an inner surface of the tube 140 at the inlet 142. The tube 140 extends into the motor housing 18 and the outlet 144 of the tube 140 extends through an opening 154 at a bottom of the motor housing 18 to deliver fluid into the area 36 that receives the user's hands. It will be appreciated that the tube may have any suitable cross-sectional shape.

The first valve 146 includes a closing member or ball 156 that is in a first or open position against a ledge in the tube 140 away from the inlet 142 allowing fluid from the reservoir 100 to enter to tube 140, and that is movable to a second or closed position as shown in FIG. 7 closing the inlet 142 when the tube 140 is deflected as described below. In the second position, the ball 156 prevents fluid in the reservoir 100 from entering the tube 140 as fluid is being dispensed. The second valve 148 includes a valve body 158 having an inlet 160, a closing member or poppet 162 biased against the inlet 160, an outlet 164, and a resilient member 166, such as a spring, that biases the poppet 162 against the inlet 160 to prevent fluid from exiting the tube 140 when a user's hands have not been detected. The poppet 160 is movable from a first or closed position shown in FIG. 7 to a second or open position away from the inlet 160 allowing fluid to flow through the inlet 160 to the outlet 164 and out of the outlet 144 of the tube assembly 106 when the tube 140 is deflected.

Turning now to the cover 22 in detail, the cover 22 is designed to surround the reservoir 100 and overlap a portion of the motor housing 18. The cover includes an opening 170 at its front through which the transparent portion 120 of the reservoir 100 is visible, openings 172 at its rear that align with the openings 46 and 42 to receive the fasteners 60, and a recessed area 174 for receiving an indication display 176.

The recessed area 174 includes an opening 178 that aligns with an opening 180 in the motor housing 18 for one or more wires to extend through for attachment to the indication display 176. The indication display is configured to be received in the recessed area 174 to be flush with the cover 22, and can include suitable icons 182 and 184, such as a water drop with a transmission symbol below it and a battery symbol. When a user's hand is detected, the icon 182 may light up or flash to provide a visual indication that the dispenser 10 has been activated. The icon 182 may also light up or flash periodically when no activation has been detected to indicate the dispenser 10 is operational, for example by flashing a light every 5 seconds.

The battery icon 184 may be lit up flash a first color, such as green, to indicate there is sufficient battery, and may be lit up or flash a second color, such as orange, to indicate the battery is low. Alternatively, the battery icon 184 may only light up or flash once the battery has reached a low power level. In either embodiment, the battery icon 184 may light up or flash to indicate low battery a predetermined number of activations before the battery can no longer operate the dispenser 10. For example, the batter icon 184 may flash orange when the battery is low to indicate there are fifty activations left before the battery can no longer operate the dispenser 10. In an embodiment, the indication display 176 can be a capacitive sensor providing an alternative method of activating the dispenser.

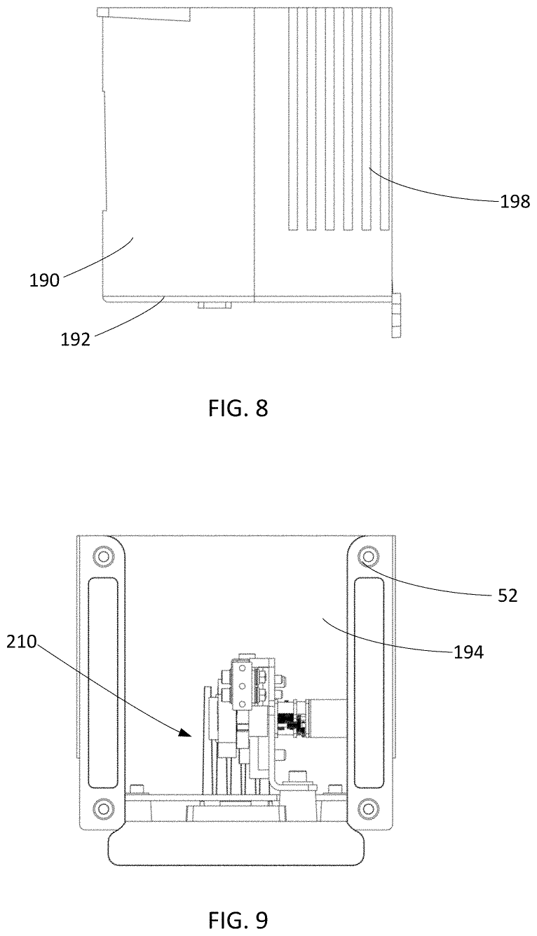

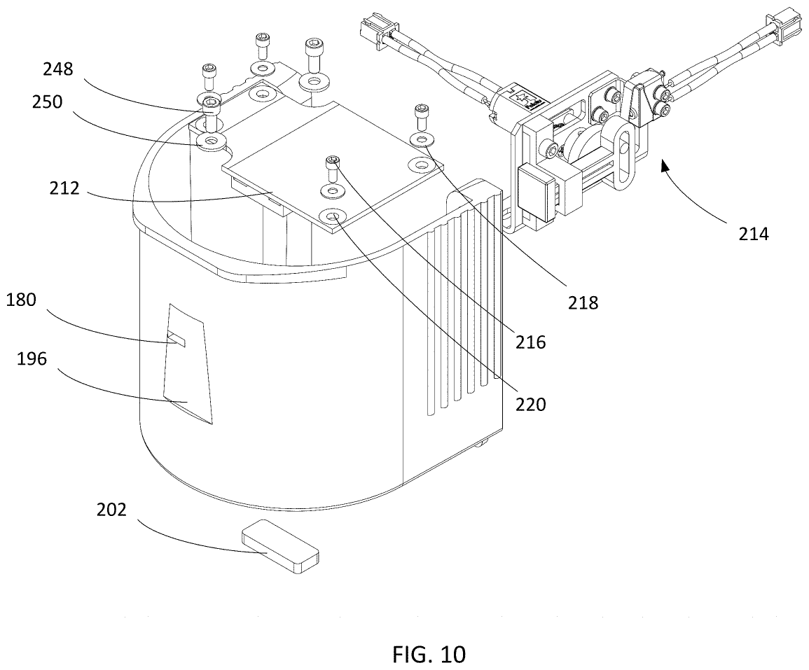

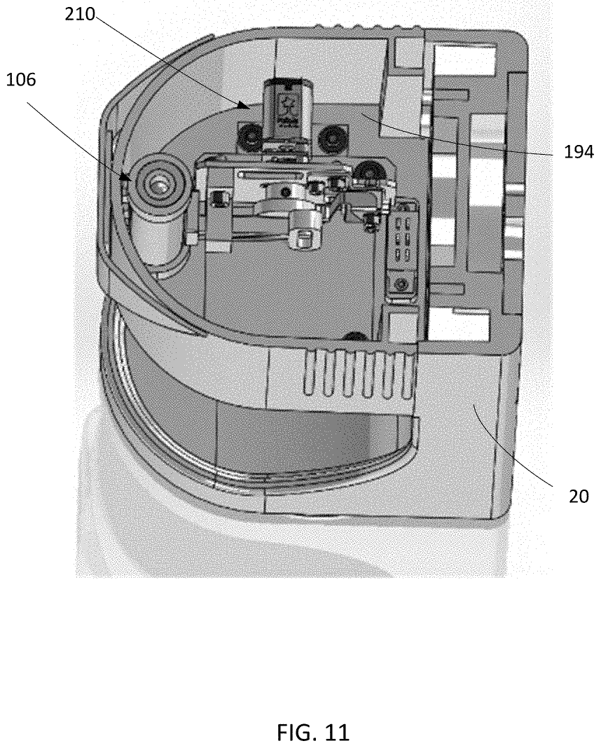

Turning additionally to FIGS. 8-11 the motor housing 18 will be described in detail. The motor housing 18 includes a wall 190 with a curved front and a bottom portion 192 that defines with the wall 190 a cavity 194. The wall 190 includes a recessed area 196 having the opening 180, projections 198 on the sides of the wall 190 serving as grip areas for the user, and the openings 52 that align with the openings 50 in the vertical portion 30 to receive the fasteners 64. The bottom portion 192 includes a plurality of openings through which various components extend. For example, the bottom portion 192 includes the opening 154 through which the outlet 144 of the tube 140 extends, an opening 200 rearward of the opening 154 through which one or more sensors 202, such as an IR sensor extends, and an opening 204 at a rear of the bottom portion 192 through which a switch 206 of a main power switch 208 extends.

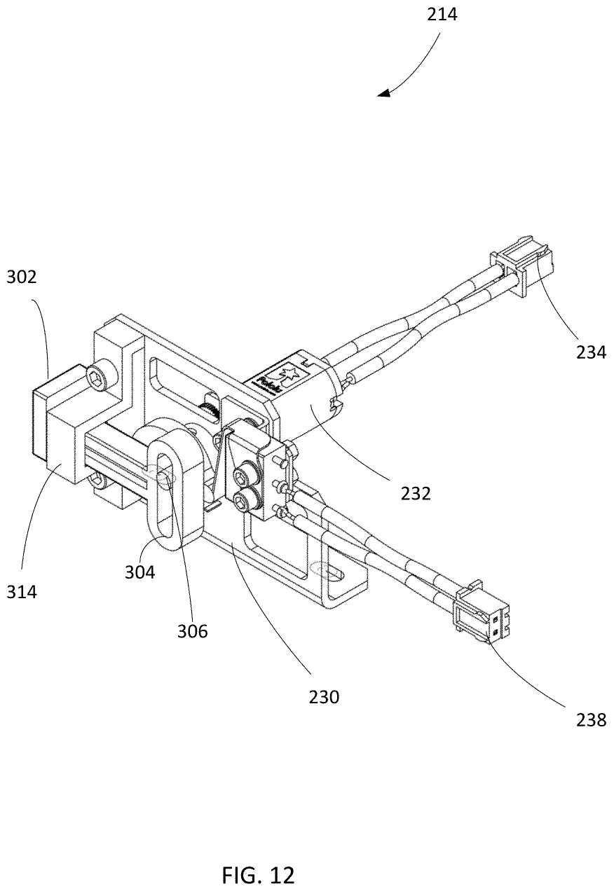

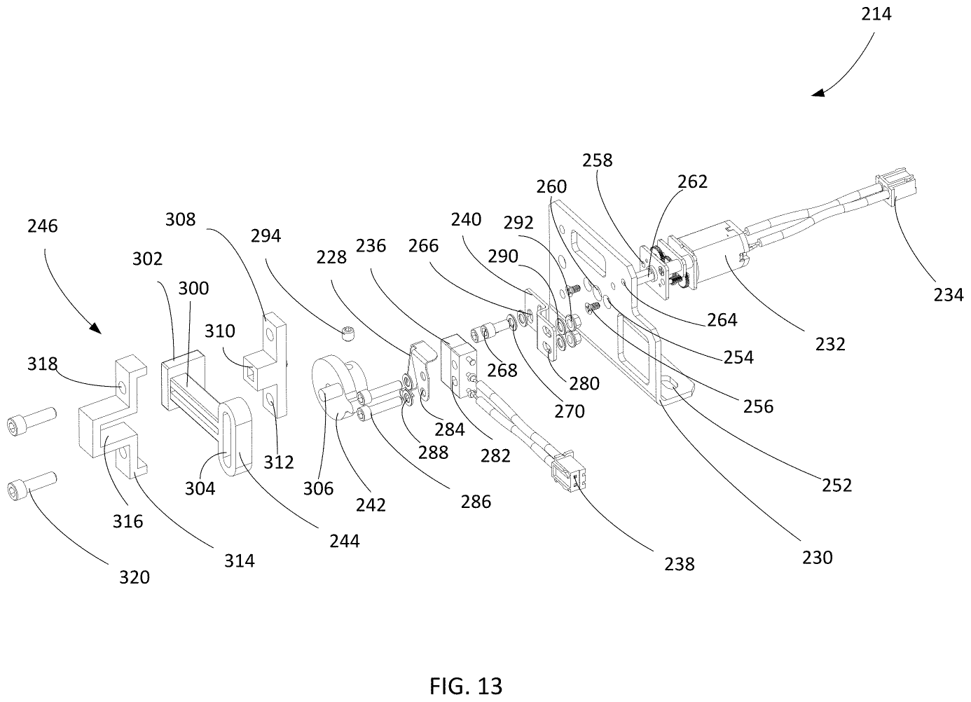

Turning additionally to FIGS. 12 and 13, a control assembly 210 will be described in detail. The control assembly 210 includes a control board 212, such as a printed circuit board assembly (PCBA), a motor assembly 214, the one or more sensor 202, and the main power switch 208. The control board 212 is coupled to the bottom portion 192 of the motor housing 18 in a suitable manner, such as by fasteners 216 surrounded by washers 218 that are received in corresponding openings 220 in the control board 212, and coupled to the battery in a suitable manner, such as by a wired connection. Coupled to the bottom of the control board 212 are the one or more sensors 202, and coupled to the rear of the control board 212 is the main power switch 208. The one or more sensors 202 and the main power switch 208 may be communicatively coupled to the control board 212 in any suitable manner, such as a direct connection, a wired connection, etc. The one or more sensors 202 may be coupled to the motor housing 18 and/or the control board 212 in any suitable manner, such as by adhesive, fasteners, etc., and the main power switch 208 may be coupled to the motor housing 18 and/or the control board 212 in any suitable manner, such as by adhesive, fasteners 222, etc. The main power switch is positioned at a rear of the assembly to prevent inadvertent activation/deactivation of the dispenser.

Turning now to the motor assembly 214, the motor assembly 214 includes a bracket 230, a motor 232 connected to the control board 212 via a connector 234, a cam switch 236 connected to the control board 212 via a connector 238, a bracket switch 240, a cam 242, an actuator 244, an actuator bracket assembly 246, and a bracket switch actuator 228. The bracket 230 may be coupled to the bottom portion 192 of the motor housing 18 in any suitable manner, such as by fasteners 248 surrounded by washers 250 that are received in openings 252 in the bracket 230 that align with corresponding openings in the bottom portion 192 of the motor housing 18. The bracket 230 can be positioned above the control board 212 toward a side of the control board 212, and the bracket 230 may include a plurality of openings for various components of the motor assembly 214. For example, the bracket 230 may include a plurality of openings 254 that may receive fasteners 256 that are received in corresponding openings 258 in the motor 232 to connect the motor 232 to the bracket 230. The bracket 230 may also include an opening 260 through which a shaft 262 of the motor 232 extends, and a plurality of openings 264 that align with corresponding openings 266 in the bracket switch 240 to receive fasteners 268 that are surrounded by washers 270. It will be appreciated that the shaft 262 may extend from the motor 232 or be otherwise connected to a shaft of the motor 232 in a suitable manner.

The bracket switch 240 may also include openings 280 that align with openings 282 in the cam switch 236 and openings 284 in the bracket switch actuator 228 to receive fasteners 286 that are surrounded by washers 288. The fasteners 286 are received in corresponding washers 290 and nuts 292 abutting the bracket switch 240. The cam 242 abuts the bracket 230 and bracket switch 240 and is attached to the shaft 262 of the motor 232 to be driven by the motor, for example by a set screw 294.

The actuator 244 includes a body 300, a hammer portion 302 at an end of the body 300 for compressing the tube 140 to deliver fluid to the user, and a slot 304 at the other end of the body 300. A projection 306 extending from the cam 242 is received in the slot 304 to drive the actuator 244 toward and away from the tube 140. The actuator 244 is held in position by the actuator bracket assembly 246, which includes a first portion 308 with a projection 310 and openings 312 on opposite sides of the projection 310, and a second portion 314 with a channel 316 and openings 318 on opposite sides of the channel 316. The openings 312 are aligned with the openings 318 to receive fasteners 320, and the projection 310 is received in the channel 316 along with the body 300 of the actuator 244 to hold the actuator 244 in position and allow it to move horizontally toward and away from the tube 140.

To install the dispenser 10, for example in the lavatory of the aircraft, the mounting bracket 80 is attached to either a wall or a counter in the lavatory via suitable fasteners received in the openings 94. If the dispenser 10 is being vertically mounted, the openings 82 are aligned with the lock pins 86 and the dispenser 10 is advanced towards the mounting bracket 80 until the lock pins 86 extend through the first portion of the openings 82. The dispenser 10 is then rotated relative to the mounting bracket 80 to move the lock pins 86 into the second portion of the openings 82 to secure the dispenser to the mounting bracket 80 and thus the wall of the lavatory. Similarly, if the dispenser 10 is being horizontally mounted, the openings 84 are aligned with the lock pins 86 and the dispenser 10 is advanced towards the mounting bracket 80 until the lock pins 86 extend through the first portion of the openings 84. The dispenser 10 is then rotated relative to the mounting bracket 80 to move the lock pins 86 into the second portion of the openings 84 to secure the dispenser to the mounting bracket 80 and thus the counter of the lavatory.

To operate the dispenser 10, the switch 206 is moved from an OFF position to an ON position. Once the dispenser is on, the icon 182 may be configured to flash to provide a visual indication to the user that the dispenser is active. When a user positions her hands in the area 36, the user's hands move below the outlet 144 before the sensor 202 is activated due to the outlet being positioned forward of the sensor. Once a portion of the user's hands are below the sensor 202, another portion of the user's hands, for example the user's palm, is positioned below the outlet 144.

When the sensor 202 detects the presence of the user's hands, the presence is communicated to the motor assembly 214. In an embodiment, the icon 182 may light up or flash to indicate to the user that the dispenser 10 has been activated. The motor 232 is thereby activated for one cycle, for example to effect one revolution of the cam 242. The motor 232 rotates effecting movement of the cam 242, which rotates to move the projection 306 within the slot 304 to move the actuator 244 from a first position to a second position. The cam 242 can complete one revolution whereby it contacts the bracket switch activator 228 causing the cam switch 236 to communicate to the control board 212 to turn off the motor 232. In the second position, the hammer portion 302 of the actuator 244 contacts the tube 140. The force of the hammer portion 302 against the tube 140 causes the biasing force of the spring 166 to be overcome and the poppet 162 to move from the first position to the second position, thereby allowing the fluid to flow from the tube 140 through the inlet 160 of the valve 148 to the outlet 164 and out of the outlet 144 of the tube assembly 106 into the user's hands. The force of the hammer portion 302 against the tube 140 also causes the ball 156 to move from the first position to the second position closing the inlet 142 of the tube assembly 106 to prevent fluid from the reservoir 100 from entering the tube 140 as fluid is being dispensed from the outlet 144.

The electronics have logic configured to provide one activation regardless of the amount of time the user's hands or other object are under the sensor 202. This prevents the reservoir 100 from being drained if an object is advertently left below the sensor 202. If the user desires more fluid, the user first removes her hands from below the sensor 202 and then repositions her hands below the sensor 202.

The aforementioned systems, components, (e.g., body, housing, reservoir assembly, sensors, among others), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

Although certain embodiments have been shown and described, it is understood that equivalents and modifications falling within the scope of the appended claims will occur to others who are skilled in the art upon the reading and understanding of this specification.

What is claimed is:

1. A touchless dispenser comprising:
a body;
a motor housing coupled to the body and defining a chamber;
a control assembly at least partially disposed in the chamber, the control assembly including a control board, a motor communicatively coupled to the control board, a cam coupled to the motor, an actuator configured to be driven between first and second positions by movement of the cam, and a sensor communicatively coupled to the control board;
a reservoir coupled to the body for holding fluid; and
a tube assembly having an inlet coupled to the reservoir to receive fluid from the reservoir and an outlet positioned forward of the sensor through which the fluid is dispensed,
wherein the sensor is configured to sense a presence of a user, which is communicated to the control board to cause the actuator to be driven from the first position to the second position to contact the tube assembly to dispense the fluid in the tube assembly to the user.

2. The touchless dispenser according to claim 1, wherein the tube assembly includes a tube having the inlet and outlet, a first valve at the inlet biased in an open position for receiving the fluid from the reservoir, and a second valve at the outlet biased in a closed position preventing the fluid from exiting the outlet until the tube assembly is contacted by the actuator.

3. The touchless dispenser according to claim 2, wherein the first valve includes a closing member that is movable from the open position to a closed position when the tube assembly is contacted by the actuator to prevent fluid from the reservoir from entering the tube during dispensing.

4. The touchless dispenser according to claim 2, wherein the second valve includes a closing member movable from the closed position to an open position when the tube assembly is contacted by the actuator to allow the fluid in the tube to exit the outlet.

5. The touchless dispenser according to claim 1, further comprising a cam switch communicatively coupled to the control board, wherein the cam switch is configured to be contacted by the cam after one revolution to communicate to the control board to turn off the motor to prevent continuous dispensing.

6. The touchless dispenser according to claim 1, further comprising an indication display at a front of the dispenser, the indication display including one or more icons for providing a visual indication to the user.

7. The touchless dispenser according to claim 6, wherein the one or more icons includes a first icon configured to light up to indication that the sensor has sensed the presence of the user, and a second icon configured to light up to indicate a power source of the dispenser has reached a low power level.

8. The touchless dispenser according to claim 7, wherein the second icon is configured to light up a predetermined number of activations before the power source can no longer power the dispenser.

9. The touchless dispenser according to claim 1, further including a vertical mounting plate coupled to a rear of the body, and a horizontal mounting plate coupled to a bottom of the body.

10. The touchless dispenser according to claim 9, where the vertical mounting plate and the horizontal mounting plate each include a plurality of spaced openings for receiving a respective lock pin of a mounting bracket.

11. The touchless dispenser according to claim 10, wherein each opening has a first portion for receiving the respective pin and a second portion smaller than the first portion for securing the horizontal or vertical mounting plate to the mounting bracket upon rotation of the horizontal or vertical mounting plate relative to the mounting bracket.

12. The touchless dispenser according to claim 1, wherein the reservoir is coupled to the body above the motor housing, and wherein the tube assembly is disposed in the chamber of the motor housing and the outlet of the tube assembly extends through a bottom of the motor housing.

13. The touchless dispenser according to claim 1, wherein the motor housing has one or more sidewalls and a bottom defining with the one or more sidewalls the chamber, and wherein the bottom includes a first opening through which the outlet of the tube assembly extends, and a second opening rearward of the first opening through which the sensor extends.

14. A touchless dispenser comprising:
a body;
a vertical mounting plate coupled to a rear of the body and including a plurality of openings for receiving respective lock pins of a mounting bracket for mounting the dispenser to a vertical surface;
a horizontal mounting plate coupled to a bottom of the body and including a plurality of openings for receiving the respective lock pins of the mounting bracket for mounting the dispenser to a horizontal surface;
a motor housing coupled to the body;
a control assembly at least partially disposed in motor housing;
a reservoir coupled to the body for holding fluid; and
a tube assembly having an inlet coupled to the reservoir to receive fluid from the reservoir and an outlet through which the fluid is dispensed.

15. The touchless dispenser according to claim 14, wherein each opening in the vertical mounting plate and horizontal mounting plate has a first portion for receiving the respective pin and a second portion smaller than the first portion for securing the horizontal or vertical mounting plate to the mounting bracket upon rotation of the horizontal or vertical mounting plate relative to the mounting bracket.

16. The touchless dispenser according to claim 14, wherein the control assembly includes a control board, a motor communicatively coupled to the control board, a cam coupled to the motor, an actuator configured to be driven between first and second positions by movement of the cam, and a sensor communicatively coupled to the control board.

17. The touchless dispenser according to claim 16, wherein the sensor is configured to sense a presence of a user, which is communicated to the control board to cause the actuator to be driven from the first position to the second position to contact the tube assembly to dispense fluid in the tube assembly to the user.

18. A method of operating a dispenser having a body, a motor housing coupled to the body, a reservoir coupled to the body for holding a fluid, and a tube assembly having an inlet and outlet, the method including:
sensing a presence of a user via an IR sensor positioned rearward of the outlet of the tube assembly;
communicating the presence of the user to a control board disposed in the motor housing;
driving a cam to rotate to drive an actuator from a first position to a second position contacting the tube assembly via a command from the control board; and
delivering fluid from the outlet of the tube assembly to the user,
wherein the cam contacts a cam switch after being driven to communicate to the control board to turn off a motor to prevent dispensing until another presence is detected.

19. The method according to claim 18, wherein the tube assembly includes a first valve movable from an open position to a closed position when the tube assembly is contacted by the actuator to prevent fluid from the reservoir from entering the tube during dispensing, and a second valve movable from a closed position to an open position when the tube assembly is contacted by the actuator to allow the fluid in the tube to exit the outlet.

20. The method according to claim 18, further comprising providing a visual indication to the user that a power source has reached a low power level a predetermined number of activations before the power source can no longer power the dispenser.
